(19) United States
(12) Patent Application Publication
(10) Pub. No.: US 2025/0197650 A1
(43) Pub. Date: Jun. 19, 2025

(54) COPOLYMERS AND METHODS OF MAKING AND USING THE SAME

(71) Applicant: 3M INNOVATIVE PROPERTIES COMPANY, St. Paul, MN (US)

(72) Inventors: Chad M. Amb, Roberts, WI (US); Cheryl L.S. Elsbernd, Woodbury, MN (US); Richard J. Pokorny, Maplewood, MN (US)

(21) Appl. No.: 18/836,283

(22) PCT Filed: Mar. 21, 2023
(86) PCT No.: PCT/IB2023/052771

§ 371 Date: Aug. 6, 2024

Related U.S. Application Data
(60) Provisional application No. 63/322,491, filed on Mar. 22, 2022.

(51) Int. Cl. C09D 5/16; C08F 220/18; C08F 220/30; C08F 220/38; C08G 77/442; C09D 133/14

(52) U.S. Cl. CPC C09D 5/1668; C08F 220/1818; C08F 220/301; C08F 220/38; C08G 77/442; C09D 5/1675; C09D 133/14; C08F 2800/20

(57) ABSTRACT

A copolymer preparable by free-radical copolymerization of components comprising at least components a) and b). Component a) comprises at least one of: i) at least one C₃-C₁₀ carboxyl-functional monoacrylate or salt thereof; or ii) at least one C₅-C₁₆ hydroxyalkyl mono(meth)acrylate. Component b) comprises at least one acrylate represented by the formula (I) Each n is independently an integer from 0 to 18, inclusive. Each X is independently O, NR¹ wherein R¹ is H or methyl, S, C(═O)O, OC(═O), C₂-C₁₀ hydrocarbylene, or a covalent bond, with the proviso that if n=0, then X is a covalent bond. Each R₂ is independently: 1) a C₅-C₅₀ hydrocarbyl group having 1 to 3 rings comprising at least one tert-butyl or C₁-C₁₂ linear alkyl group; or 2)(Formula (2)) wherein each Y is independently O, NR¹, S, C(═O)O, OC(═O), OC(═O)O, or a covalent bond, and each R³ is independently C₁-C₁₆ linear alkyl group. According to ASTM test method D3418-21 (2021) according to ASTM test method D3418-21 (2021) the copolymer has a melting extrapolated end temperature T_{efm} between −0.5 and 40° C., inclusive. Methods of making and using the copolymer are also disclosed.

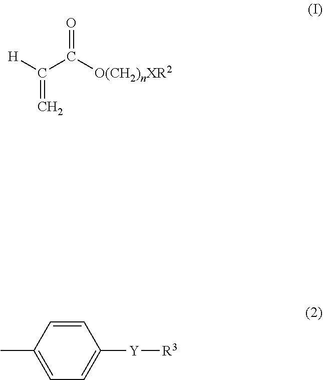

### BACKGROUND

Stain-resistance and water-repellency are important in many uses of coating materials. Water-repellent coating materials may be made by various treatment processes, including, for example, silicone and fluorochemical treatments. Recently, them has been increased emphasis on alternative coating materials. However, to date, good oil-repellency has not been successfully achieved with non-fluorochemical-based coating materials.

### SUMMARY

There remains a need for improved coating materials that better resist oily substances. Advantageously, the present disclosure provides new copolymers that may repel water and exhibit enhanced advancing contact angles with oils as compared to the state of the art, and which may be fluorochemical-free and contain little or no silicone.

In a first aspect, the present disclosure provides a copolymer preparable by free-radical copolymerization of components comprising:
a) 1 to 85 weight percent of at least one of:
   i) at least one C₃-C₁₀ carboxyl-functional monoacrylate or salt thereof; or
   ii) at least one C₅-C₁₆ hydroxyalkyl mono(meth)acrylate;
b) 15 to 99 weight percent of at least one acrylate represented by the formula

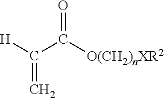

wherein:
   each n is independently an integer from 0 to 18, inclusive;
   each X is independently O, NR¹ wherein R¹ is H or methyl, S, C(═O)O, OC(═O), C₂-C₁₀ hydrocarbylene, or a covalent bond, with the proviso that if n=0, then X is a covalent bond; and
   each R² is independently:
      1) a C₅-C₅₀ hydrocarbyl group having 1 to 3 rings comprising at least one tert-butyl or C₁-C₁₂ linear alkyl group; or
      2)

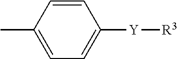

wherein each Y is independently O, NR¹, S, C(═O)O, OC(═O), OC(═O)O, or a covalent bond, and each R³ is independently C₁-C₁₆ linear alkyl group; and
c) optionally up to 55 weight percent of at least one C₁₄-C₃₀ linear alkyl mono(meth)acrylate, wherein all of the preceding weight percents are based on the weight of the copolymer, and wherein according to ASTM test method D3418-21 (2021) the copolymer has a melting extrapolated end temperature T_{efm} between 0.5 and 40° C., inclusive.

In another aspect, the present disclosure provides a method of using the copolymer, the method comprising applying the copolymer to a substrate.

In yet another aspect, the present disclosure provides a method of copolymerizing monomer components, the method comprising:
combining a free-radical initiator with free-radically copolymerizable monomer components comprising:
   a) 1 to 85 weight percent of at least one of:
      i) at least one C₃-C₁₀ carboxyl-functional monoacrylate or salt thereof; or
      ii) at least one C₅-C₁₆ hydroxyalkyl mono(meth)acrylate;
   b) 15 to 99 weight percent of at least one acrylate represented by the formula

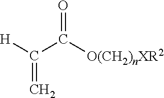

wherein:
   each n is independently an integer from 0 to 18, inclusive;
   each X is independently O, NR¹ wherein R¹ is H or methyl, S, C(═O)O, OC(═O), C₂-C₁₀ hydrocarbylene, or a covalent bond, with the proviso that if n=0, then X is a covalent bond; and
   each R² is independently:
   1) a C₅-C₅₀ hydrocarbyl group having 1 to 3 rings comprising at least one tert-butyl or C₁-C₁₂ linear alkyl group; or
   2)

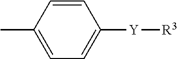

wherein each Y is independently O, NR¹, S, C(═O)O, OC(═O), OC(═O)O, or a covalent bond, and each R³ is independently a C₁-C₁₆ linear alkyl group; and
c) optionally up to 55 weight percent of at least one C₁₄-C₃₀ linear alkyl mono(meth)acrylate, wherein all of the preceding weight percents are based on the total weight of the copolymer, and
decomposing the free-radical initiator and causing copolymerization of the monomer components.

As used herein:
the term “ASTM” refers to ASTM International, 100 Barr Harbor Drive, West Conshohocken, Pennsylvania;
the term “(meth)acryl” includes “acryl” and/or “methacryl”; and
the generic expression “Cₓ-C_{y}” means having from x to y carbon atoms, inclusive.

Features and advantages of the present disclosure will be further understood upon consideration of the detailed description as well as the appended claims.

### DETAILED DESCRIPTION

Copolymers according to the present disclosure may be preparable by (e.g., prepared by) free-radical copolymerization of components comprising components a), b), and optionally c).

Component a) comprises at least one of: at least one C₃-C₁₀ carboxyl-functional monoacrylate or salt thereof; or at least one C₅-C₁₆ hydroxyalkyl mono(meth)acrylate.

Component a) may comprise 1 to 85 weight percent, 1 to 70 weight percent, 1 to 60 weight percent, 1 to 50 weight percent, 1 to 40 weight percent, 2 to 35 weight percent, or 5 to 30 weight percent of the weight of the copolymer.

Exemplary C₃-C₁₀ carboxyl-functional monoacrylates include acrylic acid, 2-carboxyethyl acrylate, 3-carboxypropyl acrylate, 4-carboxybutyl acrylate, 5-carboxypentyl acrylate, 6-carboxyhexyl acrylate, 7-carboxyheptyl acrylate, 2-carboxyphenyl acrylate, 4-carboxyphenyl acrylate, succinic acid C₁-C₇ monoalkyl esters (e.g., succinic acid monomethyl ester, succinic acid monoethyl ester, succinic acid monobutyl ester, succinic acid monoheptyl ester), salts of the foregoing (e.g., alkali metal salts and quaternary ammonium salts), and combinations thereof.

Exemplary C₅-C₁₆ hydroxyalkyl mono(meth)acrylates include 2-hydroxyethyl (meth)acrylate, 3-hydroxypropyl (meth)acrylate, 2-hydroxy-1-methylethyl (meth)acrylate, 2-hydroxy-1-methylethyl (meth)acrylate, 4-hydroxybutyl (meth)acrylate, 5-hydroxypentyl (meth)acrylate, 6-hydroxyhexyl (meth)acrylate, 8-hydroxyoctyl (meth)acrylate, 10-hydroxydecyl (meth)acrylate, 12-hydroxydodecyl (meth)acrylate, diethylene glycol mono(meth)acrylate, triethylene glycol mono(meth)acrylate, tetraethylene glycol mono(meth)acrylate, 2-hydroxyethylphenyl (meth)acrylate, 2-hydroxyethoxyphenyl (meth)acrylate, and 2-(2′-hydroxyethoxy)ethoxyphenyl (meth)acrylate, and combinations thereof.

Many carboxyl-functional acrylates and hydroxyl-functional (meth)acrylates suitable for component a) are commercially available. Others can be made according to readily accessible known methods. Exemplary methods include those described in Curci et al., “Synthesis of Functionalized Acrylates”, Organic Preparations and Procedures International, 1993, 25(6), pp. 649-657.

Component b) comprises at least one acrylate represented by the formula

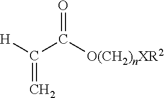

Each n is independently an integer from 0 to 18, inclusive. Examples include 0, 1, 2, 3, 4, 5, 6, 7, 8, 9, 10, 11, 12, 13, 14, 15, 16, 17, and 18.

Each X, which is a divalent group, may be independently selected from the divalent groups 0, NR¹ wherein R¹ is H or methyl, S, C(═O)O, OC(═O), C₂-C₁₀ hydrocarbylene (e.g., ethylene, propylene, butylene, hexylene, octylene, decylene, phenylene, methylpropylene), or a covalent bond (i.e., as though X is not present in the formula) with the proviso that if n=0, then X is a covalent bond.

Each R² is independently a C₅-C₅₀ hydrocarbyl group having 1 to 3 rings; or is represented by

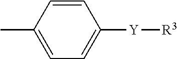

wherein each Y may be independently selected from the divalent groups 0, NR¹ as previously defined, S, C(═O)O, OC(═O)O, or a covalent bond, and each R³ is independently a C₁-C₁₆ linear alkyl group. Exemplary R³ groups include methyl, ethyl, propyl, butyl, pentyl, hexyl, heptyl, octyl, nonyl, decyl, undecyl, dodecyl, tridecyl, tetradecyl, pentadecyl and hexadecyl.

In some embodiments, the C₅-C₅₀ hydrocarbyl group having 1-3 rings comprises a single aromatic ring that is substituted by an alkyl group terminated by either a single methyl group or a tert-butyl group. Groups include but are not limited to methyl, ethyl, n-propyl, tert-butyl, n-butyl, n-pentyl, n-heptyl, n-octyl, n-nonyl, n-decyl, n-undecyl, n-dodecyl. In some embodiments, the aromatic hydrocarbyl group is substituted in the para position.

Component b) may comprise 15 to 99 weight percent, 17.5 to 99 weight percent, 25 to 99 weight percent, 35 to 99 weight percent, 45 to 99 weight percent, 55 to 99 weight percent, 65 to 99 weight percent, 65 to 98 weight percent, or 70 to 95 weight percent, based on the total weight of the copolymer.

In some embodiments, component b) melts at a temperature of at most 49° C., at most 45° C., at most 40° C., at most 35° C., or even at most 30° C.; however, this is not a requirement.

Many acrylates suitable for component b) are commercially available. Others can be made according to readily accessible known methods.

In some embodiments, component a) comprises less than 40 weight percent of the copolymer and wherein the weight percent of component a) is at most 10 percent larger than the weight percent of component b).

Optional component c) comprises at least one C₁₄-C₃₀ linear alkyl mono(meth)acrylate. Exemplary C₁₄-C₃₀ linear alkyl mono(meth)acrylates include tetradecyl (meth)acrylate, pentadecyl (meth)acrylate, hexadecyl (meth)acrylate, heptadecyl (meth)acrylate, octadecyl (meth)acrylate, nonadecyl (meth)acrylate, icosyl (meth)acrylate, henicosyl (meth)acrylate, docosyl (meth)acrylate, tricosyl (meth)acrylate, tetracosyl (meth)acrylate, pentacosyl (meth)acrylate, hexacosyl (meth)acrylate, heptacosyl (meth)acrylate, octacosyl (meth)acrylate, nonacosyl (meth)acrylate, and triacontyl (meth)acrylate.

Optional component c) may comprise up to 55 weight percent, up to 52.5 weight percent, up to 30 weight percent, up to 25 weight percent, up to 20 weight percent, up to 15 weight percent, up to 10 weight percent, or up to 5 weight percent, based on the weight of the copolymer.

In some embodiments, the sum of the weight percent of b)+c) is greater than 30 weight percent, 32.5 weight percent, 35 weight percent based on the weight of the copolymer.

Many linear alkyl (meth)acrylates suitable for optional component c) are commercially available. Others can be made according to readily accessible known methods.

In those embodiments in which component c) is present, it may be desirable to use components b) and c) in a weight ratio of greater than 0.5 (e.g., at least 1:2; at least 1:1.5, at least 1:1, at least 3:2, at least 7:3, or at least 4:1), although this is not a requirement.

Minor amounts (e.g., less than 5 combined percent by weight, less than 2 combined percent by weight, or less than 1 combined percent by weight) of additional copolymerizable monomers may be present in the copolymer, or not; however, if present they should not adversely affect the oil and water repellency properties of the copolymer.

Copolymers according to the present disclosure exhibit a melting extrapolated end temperature between 0.5 and 40° C. This transition can be measured according to ASTM test method D3418-21 (2021) “Standard Test Method for Transition Temperatures and Enthalpies of Fusion and Crystallization of Polymers by Differential Scanning Calorimetry”. Measurable parameters of the transitions include Tₑᵢₘ=the melting extrapolated onset temperature in ° C.; T_{efm′}=the melting extrapolated end temperature in ° C.; Tₚₘ=the melting peak temperature in ° C.; T_{eic}=the crystallization extrapolated onset temperature in ° C.; T_{pc}=crystallization peak temperature in ° C.; T_{efc}=the crystallization extrapolated end temperature in ° C.; DH_{f}=the heat of fusion in joules/gram (J/g); and DH_{c}=the heat of crystallization in joules/gram (J/g).

In some embodiments, the copolymers exhibit a T_{efm}, i.e., the melting extrapolated end temperature, between 0.5 and 40° C., between 1 and 40° C., between 2 and 40° C., between 3 and 40° C., between 0.5 and 39° C., between 0.5 and 38° C., between 3 and 37° C., or between 2 and 38° C.

In some embodiments, the T_{eic}, i.e., the crystallization extrapolated onset temperature, is between −11 and 29° C., between −11 and 28° C., between −11 and 27° C., or between −10.5 and 29° C., between −10.5 and 28° C., between −10.5 and 27° C., between −10.5 and 26° C., or between −10.25 and 26° C.

In some embodiments, the T_{pc}, i.e., crystallization peak temperature, is between −20.5 and 28° C., between −15 and 28° C., between −14 and 28° C., or between −14 and 28° C., between −14 and 27° C., between −14 and 25° C., −13 and 25° C., or between −15 and 26° C. In some embodiments the T_{pc}, i.e., crystallization peak temperature, ° C., is below 28° C., below 27° C., or below 26° C.

In some embodiments, the Tₚₘ, i.e., the melting peak temperature, ° C., is between −12 and 38° C., −7 and 38° C., −6 and 38° C., −5 and 38° C., −7 and 37° C., −6 and 37° C., or −5 and 35° C. In some embodiments the Tₚₘ, i.e., the melting peak temperature, ° C., is below 38° C., below 37° C., below 36° C. or below 35° C.

Optionally stabilizers may be added to prolong shelf-life. Examples include hydroquinone, 4-tert-butylcatechol (TBC), methoxyphenol (MEHQ), butylated hydroxytoluene (BHT), and combinations thereof. Many more are known to those of ordinary skill in the art and are commercially available. Minimum effective amounts are typically used if any so as not to unduly interfere with the copolymerization reaction.

Without wishing to be bound by theory, the present inventors believe that crystalline melt and freezing transitions near room temperature allow a degree of liquid crystalline behavior that allows the proper mechanical properties for high contact angles with liquids (deformable material) while still not allowing a strong interaction between the liquid and the surface. Materials that are too hard do not allow a high contact angle because they cannot easily deform, but materials that are soft but not crystalline interact too strongly and want to wet out completely.

In preferred embodiments, the copolymer contains at most 13 weight percent, at most 10 weight percent, at most 7 weight percent, at most 4 weight percent, or at most 1 weight percent of polydimethylsiloxane segments; however, this is not a requirement. In some embodiments, the copolymer is free of polydimethylsiloxane segments.

Copolymers according to the present disclosure can applied to a substrate (typically an exposed surface of a substrate); for example, to impart water and/or oil repellent properties to the substrate. The copolymer may be coated from a liquid vehicle as a solution or dispersion or extruded in a melt state, for example. Suitable liquid vehicles may include, for example, water (especially in the case of dispersions), organic solvents such ketones, ethers, esters, aromatics, halocarbons, and combinations thereof.

The copolymer may be applied by any suitable method including, for example, spray coating (including from an aerosol can), extrusion, dip coating, roll coating, stamping, and brushing. Any coating weight may be used, but preferably a minimum effective amount is used. Often, this will depend on the substrate and intended conditions of use.

Exemplary substrate materials include metal, glass, plastic, leather, fabric, wood, and masonry. Exemplary substrates include apparel (especially outer apparel such as gloves, jackets, coats, hats, and shoes), upholstery, tents, awnings, umbrellas, rugs, carpets, furniture, boat hulls, and automotive paints and clearcoats.

Copolymers according to the present disclosure can generally be prepared by combining at least the corresponding free-radically polymerizable components, often in solvent (but this is not a requirement) and typically in the presence of a free-radical polymerization initiator, although other methods such as electron beam radiation or gamma radiation may also be used. Exemplary free-radical initiators include thermal initiators such as thermally decomposable peroxides (e.g., benzoyl peroxide, chlorobenzoyl peroxide, methyl ethyl ketone peroxide), and azo compounds (e.g., azobisisobutyronitrile). Free-radical redox initiators and free-radical photoinitiators may also be used instead or in combination with the foregoing thermal free-radical initiators. Selection of polymerization conditions and initiators is within the capabilities of those of ordinary skill in the relevant art.

Objects and advantages of this disclosure are further illustrated by the following non-limiting examples, but the particular materials and amounts thereof recited in these examples, as well as other conditions and details, should not be construed to unduly limit this disclosure.

### Examples

Unless otherwise noted, all parts, percentages, ratios, etc. in the Examples and the rest of the specification are by weight. Abbreviations: RBF=round bottom flask; L=Liters; TLC=thin layer chromatography; MB=Master batch utilized in more than one polymerization; m. p.=melting point; ntd=no transitions detected in the DSC data; tgd=a glass transition was detected in the DSC data but no crystalline melting or freezing transitions were detected; *=a broad weak crystalline transition was detected between −25° C. and 30° C. but precise assignments were not possible. Table 1, below, reports materials used in the Examples and their sources.

In the following Examples, working examples are indicated by the prefix “EX-” and Comparative Examples are indicated by the prefix “CE-”.

TABLE 1

| ABBREVIATION | DESCRIPTION | SOURCE |
|---|---|---|
| AA | acrylic Acid | Sigma-Aldrich, |
| | | St. Louis, Missouri |
| ODA | octadecyl acrylate (Miramer M180) | Miwon Specialty Chemicals, |
| | | Exton, Pennsylvania |
| VAZO 67 | 2,2′-Azobis(2-methylbutyronitrile) | Sigma-Aldrich |
| 1N HCl | 1N hydrochloric acid | JT Baker (Avantor), |
| | | Radnor, Pennsylvania |
| DMF | N,N-dimethylformamide | EMD Millipore, |
| | | Burlington, Massachusetts |
| KOH | potassium hydroxide, pellets | Alfa Aesar, Tewksbury, |
| | | Massachusetts |
| p-thiocresol | 4-methylbenzenethiol | Alfa Aesar |
| p-cresol | 4-methylphenol | Alfa Aesar |
| NaH | sodium hydride, 57-63 wt. % | Alfa Aesar |
| | dispersion in oil | |
| | N,N-diisopropylethylamine | Alfa Aesar |
| MgSO₄ | magnesium Sulfate, Anhydrous | EMD Millipore |
| CH₂Cl₂ | dichloromethane | EMD Millipore |
| HPA | hydroxypropyl acrylate (mixture | TCI America, |
| | of 2-hydroxypropyl and 2-hydroxy- | Portland, Oregon |
| | 1-methylethyl acrylate) (stabilized | |
| | with MEHQ) | |
| | heptane | EMD Millipore |
| | acryloyl chloride | Sigma-Aldrich |
| | 11-bromo-1-undecanol | Oakwood Chemical, |
| | | Estill, South Carolina |
| KI | potassium iodide | EMD Millipore |
| Silica Gel | silica gel 60, 230-400 mesh, | Sigma-Aldrich |
| | 40-60 microns particle size | |
| 2EHA | 2-ethylhexyl acrylate | Sigma-Aldrich |
| HEMA | 2-hydroxyethyl methacrylate, | Evonik Industries AG, |
| | available as VISOMER 98 | Essen, Germany |
| MAA | methacrylic acid | Sigma-Aldrich |
| HMA | n-hexyl methacrylate | Alfa Aesar |
| TDA | n-tetradecyl acrylate | Alfa Aesar |
| HDA | n-hexadecyl acrylate | Alfa Aesar |
| tBA | tert-butyl acrylate | Alfa Aesar |
| | xylenes | EMD Millipore |
| PM | 1-methoxy-2-propanol | EMD Millipore |
| | sodium carbonate | EMD Millipore |
| | 4-methylphenylboronic acid | Oakwood Chemical |
| | 4-iodophenol | Alfa Aesar |
| HCl | concentrated hydrochloric acid | EMD Millipore |
| 4-butylphenol | 4-n-butyl phenol | TCI America |
| | 4-ethylphenol | Sigma-Aldrich |
| | 9-bromo-1-nonanol | Oakwood Chemical |
| | 3,4-dimethylphenol | TCI America |
| | 4-chlorobenzenethiol | Alfa Aesar |
| | 2-napthol | Alfa Aesar |
| | 1-bromooctadecane | Alfa Aesar |
| | Phenol | Alfa Aesar |
| | 4-iodophenol | Alfa Aesar |
| | 4-tert-butylphenylboronic acid | Oakwood Chemical |
| 10% Pd/C | Palladium, 10 wt % on | Sigma-Aldrich |
| | activated carbon | |
| | Methacrylic anhydride | Alfa Aesar |
| DMAP | 4-dimethylaminopyridine | Alfa Aesar |
| | 1-bromohexane | Alfa Aesar |
| DDA | n-dodecyl acrylate, tech. 90% | Alfa Aesar |
| ODMA | stearyl methacrylate | TCI America |
| | 4-tert-butylphenol | Alfa Aesar |

### Test Methods:

### Melting Point Test

Melting point (m. p.) of the monomers was determined using a Thomas Hoover capillary melting point apparatus, (Arthur H. Thomas Company, Philadelphia, Pennsylvania) according to ASTM E324-16, except that the oil bath was not preheated to 15° C. below the expected melting range since the melting range of some of the compounds was only slightly above room temperature. The starting point was 20-22° C. for all tests. Benzophenone was used as a melting point standard; m. p.=47-49° C.

### Contact Angle Test

Contact angle measurements were performed between 2 and 4 hours after oven drying the coatings. Water and hexadecane contact angles of each sample were measured using a Ramé-Hart goniometer (Ran-d-Hart Instrument Co., Succasunna, New Jersey). Advancing (θ_{adv}) and receding (θ_{rec}) angles were measured using deionized water (H₂O) or hexadecane (HD) supplied via a steel syringe needle of 0.028 in (0.71 mm) outer diameter into or out of sessile droplets.

A mechanical syringe pump was used to dispense water, and hexadecane was delivered via syringing by hand. The measurement of the contact angles followed ASTM D7334-08 (reapproved 2022) with the following exceptions and specifications. The room relative humidity was not controlled.

The advancing contact angle for water was determined by placing a 10-15 microliter drop of water onto the substrate, wherein the needle tip was immersed in the drop, and then waiting 10 seconds. The initial needle height was 1.5-2 mm. 0.5-Microliter aliquots of water were then added to the drop and contact angle measured using a 0.1 millisecond (ms) delay time. The aliquots of water were continually added until the liquid-solid contact points moved, i.e., the liquid advanced farther on the surface of the substrate. The advancing contact angle is the maximum angle measurable before at least one of the liquid-solid contact points moved. In the cases where the contact angle exceeded 120 degrees this often occurred very quickly and suddenly to a much lower angle.

The receding contact angle for water was then determined by ensuring that at least 20 microliters of water had been dispensed, and if not then dispensing more water until it contains at least 20 microliters. 0.5-Microliter aliquots of water were then removed from the drop and the contact angle was measured using a 0.1 ms delay time between dispensing and measurement. The receding contact angle is the minimum angle measurable before at least one of the liquid-solid contact points moves. The needle tip may have been moved closer to the surface of the film if the removal of water resulted in the breaking of contact between the drop and the needle before the receding contact angle was observable. The advancing and receding contact angles for hexadecane were recorded in similar manner, except that the syringe aliquots were dispensed by hand. The delay time between aliquot dispensing and measurement for hexadecane was less than 0.5 second and the initial height of the needle above the substrate was 1-1.5 millimeters (mm). Advancing contact angles of less than 10 degrees and receding contact angles of less than 20 degrees were deemed unmeasurable and are denoted by a (-).

### Thin Layer Chromatography

Thin layer chromatography (TLC) was performed using TLC silica gel 60 F₂₅₄ coated 2.5 cm×7.5 cm glass plates from Merck KGaA, Darmstadt, Germany.

### Differential Scanning Calorimetry (DSC)

Samples for DSC were prepared by casting 1-3 mL of polymer solution onto a polytetrafluoroethylene plate, and the solvent was allowed to evaporate for at least 16 hours at room temperature. Samples were then placed in an oven at 80° C. for 15-30 minutes to remove solvent. 4-8 mg of dried sample was transferred to a Tzero aluminum sample pans and sealed with Tzero hermetic lids from TA Instruments, New Castle Delaware. Differential scanning calorimetry was performed using a DSC 2500 discovery series calorimeter from TA Instruments, New Castle, Delaware, according to ASTM D3418-21 with the following specifications. Samples were equilibrated at −50° C. for 5 minutes, then ramped in a heating cycle at 10° C./min to 200° C., followed by a cooling cycle to −50° C. at 5° C./min, followed by a heating cycle at 10° C./min to 200° C. Data was processed using Trios software from TA Instruments. The preliminary heating cycle data was discarded and the first cooling cycle and second heating cycle data were reported. If two thermal transitions were detected in the same cycle, only the data for the highest temperature transition is reported. Thermal transitions are reported where:
Tₑᵢₘ=melting extrapolated onset temperature, ° C.,
T_{efm}=melting extrapolated end temperature, ° C.,
Tₚₘ=melting peak temperature, ° C.
T_{eic}=crystallization extrapolated onset temperature. ° C.,
T_{pc}=crystallization peak temperature. ° C.,
T_{efc}=crystallization extrapolated end temperature, ° C.
ΔH_{f}=heat of fusion, (J/g)
ΔH_{c}=heat of crystallization, (J/g)

### Synthesis of 11-(p-tolylsulfanyl)undecan-1-ol)

NaH (9.0 g, 225 mmol) was charged in a 2-L, 3 neck RBF fitted with internal thermometer and magnetic stirrer, and the flask was evacuated and backfilled with nitrogen twice. Under heavy flow of nitrogen, the solid NaH was washed with 200 mL heptane, and the heptane decanted. This was repeated. DMF (500 mL) was then added. p-Thiocresol (30.5 g, 246 mmol) was then added in portions under heavy flow of nitrogen, keeping bubbling under control. The material was then heated to 70° C. until bubbling stopped. KI (5 g, 30 mmol) and 11-bromo-1-undecanol (50.0 g, 199 mmol) was then added, and the mixture was heated to 80° C. for 16 hours. The solution was cooled to room temperature. This was poured into a mixture 5% aqueous KOH and 500 mL of 30% ethyl acetate in heptane in a separatory funnel. The mixture was shaken, separated, and the aqueous phase was again extracted with 500 mL 30% ethyl acetate in heptane. The combined organic extracts were then washed with 500 mL of 5% aqueous KOH, and then 500 mL DI water. The organic fraction was then dried over MgSO₄ and filtered over a short plug of silica gel. This was concentrated by rotary evaporation to give 53.6 g (91.5%) of a white solid.

### Synthesis of 11-(p-tolylsulfanyl)undecyl prop-2-enoate (M1)

11-(p-Tolylsulfanyl)undecan-1-ol (53.0 g, 180 mmol) was charged in a 1-L, 3 necked RBF fitted with internal thermometer, addition funnel, magnetic stirrer, and nitrogen inlet. Nitrogen was blanketed over the material. Dichloromethane (650 mL) was then added, and the alcohol was allowed to dissolve. Acryloyl chloride (20.4 g, 225 mmol) was then added to the solution, which was then cooled to ˜4° C. in an ice bath. N,N-diisopropylethylamine (25.5 g, 197 mmol) was then added dropwise to the mixture, keeping the temperature below 10° C. The material was stirred 15 minutes and then allowed to warm to room temperature. TLC analysis (20% ethyl acetate in heptane) was performed and this showed some starting material remaining. Additional N,N-diisopropylethylamine (4 g, 21 mmol) and acryloyl chloride (2 g, 22 mmol) were added, and the mixture was allowed to stir overnight at room temperature. TLC analysis indicated the disappearance of the starting material. The mixture was then poured into 500 mL of 5% aqueous KOH and shaken in a separatory funnel. The aqueous fraction was extracted with 200 mL dichloromethane, and then the combined organic fractions were washed with 500 mL 1M HCl, followed by 500 mL deionized water. The organic fraction was then diluted by 800 mL heptane, dried over MgSO₄, and filtered over a short plug of silica gel. The solvent was then evaporated by rotary evaporation, and the resulting solid was recrystallized from heptane to give 47.9 g (76.4%) of a white crystalline solid; m. p.=30-31° C.

### Synthesis of 11-(4-isopropylphenyl)sulfanylundecan-1-ol

NaH (13.0 g, 325 mmol) was charged in a 2-L, 3 neck RBF fitted with an internal thermometer and a magnetic stirrer, and the flask was evacuated and backfilled with nitrogen twice. Under heavy flow of nitrogen, the solid NaH was washed with 200 mL heptane, and the heptane decanted. This was repeated. DMF (650 mL) was then added. 4-isopropylthiophenol (50.0 g, 328 mmol) was then added in portions under heavy flow of nitrogen, keeping bubbling under control. The material was then heated to 70° C. until bubbling stopped. KI (5 g, 30 mmol) and 11-bromo-1-undecanol (79.0 g, 314 mmol) was then added, and the mixture was heated to 80° C. for 16 hours. The solution was cooled to room temperature. This was poured into a mixture 5% aqueous KOH and 500 mL of 30% ethyl acetate in heptane in a separatory funnel. The mixture was shaken, separated, and the aqueous phase was again extracted with 500 mL 30% ethyl acetate in heptane. The combined organic extracts were then washed with 500 mL of 5% aqueous KOH, and then 500 mL DI water. The organic fraction was then dried over MgSO₄ and filtered over a short plug of silica gel. This was concentrated by rotary evaporation to give 98.7 g (97.3%) of a white solid.

### Synthesis of 11-(4-isopropylphenyl)sulfanylundecyl prop-2-enoate (M2)

11-(4-Isopropylphenyl)sulfanylundecan-1-ol (98.7 g, 180 mmol) was charged in a 1-L, 3 necked RBF fitted with internal thermometer, addition funnel, magnetic stirrer, and nitrogen inlet. Nitrogen was blanketed over the material. Dichloromethane (650 mL) was then added, and the alcohol was allowed to dissolve. Acryloyl chloride (34.6 g, 382 mmol) was then added to the solution, which was then cooled to ˜4° C. in an ice bath. N,N-diisopropylethylamine (43.4 g, 336 mmol) was then added dropwise to the mixture, keeping the temperature below 10° C. The mixture was then poured into 500 mL of 5% aqueous KOH and shaken in a separatory funnel. The aqueous fraction was extracted with 200 mL dichloromethane, and then the combined organic fractions were washed with 500 mL 1M HCl, followed by 500 mL deionized water. The organic fraction was then diluted by 800 mL heptane, dried over MgSO₄, and filtered over a short plug of silica gel. The solvent was then evaporated by rotary evaporation to give 108 g (94.0%) of a colorless liquid.

### Preparation of (11-(4-methylphenoxy)undecan-1-ol)

NaH (14.0 g, 350 mmol) was charged in a 2-L, 3-necked RBF fitted with internal thermometer and magnetic stirrer, and the flask was evacuated and backfilled with nitrogen twice. Under heavy flow of nitrogen, the solid NaH was washed with 200 mL heptane, and the heptane decanted. This was repeated. DMF (800 mL) was then added. p-cresol (40.0 g, 370 mmol) was then added in portions under heavy flow of nitrogen, keeping bubbling under control. The material was then heated to 70° C. until bubbling stopped. KI (5 g, 30 mmol) and 11-bromo-1-undecanol (75 g, 299 mmol) was then added, and the mixture was heated to 80° C. for 16 hours. The solution was cooled to room temperature. This was poured into a mixture of 500 mL of water with 8% aqueous KOH and 500 mL of 30% ethyl acetate in heptane in a separatory funnel. The mixture was shaken, separated, and the aqueous phase was again extracted with 500 mL 30% ethyl acetate in heptane. The combined organic extracts were then washed with 500 mL of 4% aqueous KOH, and then 500 mL DI water. The organic fraction was then dried over MgSO₄, and 55 g of silica gel was added and the mixture stirred overnight. The mixture was then filtered and concentrated by rotary evaporation to give 74.0 g (89.0%) of an off-white solid.

### Synthesis of 11-(4-methylphenoxy)undecyl prop-2-enoate (M3)

11-(4-Methylphenoxy)undecan-1-ol (62.3 g, 224 mmol) was charged into a 2-L, 3 neck RBF fitted with thermometer, magnetic stir bar, and addition funnel, and then evacuated and backfilled with nitrogen. Dichloromethane (800 mL) and acryloyl chloride (22.3 g, 280 mmol) were then added, and the mixture cooled to ˜5° C. N,N-diisopropylethylamine (30.5 g, 236 mmol) was added to the addition funnel, and was added dropwise keeping the temperature of the reaction mixture under 10° C. After the addition, the mixture was warmed to room temperature and stirred 1 hour. TLC (30% ethyl acetate in heptane) indicated complete consumption of the starting material alcohol. The mixture was then washed with 500 mL 5% aqueous KOH. This was extracted 2×100 mL dichloromethane. The combined organic extracts were then washed with 500 mL of a 5% conc. HCl/water solution, and then 500 mL deionized water. The extracts were dried over MgSO₄, and diluted with 1000 mL heptane. 30 g of silica gel was added and this was stirred for 10 minutes, and then filtered, and evaporated to give 70.5 g (94.7%) of a faintly orange liquid. The product was recrystallized from heptane to give 62.2 g (83.6%) of a white crystalline solid; m. p.=40-41.5° C.

### Synthesis of 4′-methyl[1,1′-biphenyl]-4-ol

Sodium carbonate (117 g, 1.10 mol) was charged into a 3 L, 3 neck RBF with internal thermometer and magnetic stirrer, and 1750 mL water was added and the mixture was stirred until the solid was dissolved. 4-methylphenylboronic acid (50.0 g, 368 mmol), 4-iodophenol (81 g, 368 mmol), and 10% palladium on carbon (1.7 g) were added as solids, and the mixture was heated to 90° C. A thick precipitate occurred. The flask was heated at 90° C. for 4 hours and then cooled to RT. The pH was carefully adjusted below 5 with concentrated HCl, and the product was filtered. The solid was taken up in 1.5 L hot methanol, filtered to remove carbon black, and 500 mL water was added to the filtrate, the filtrate was heated to boiling, and then cooled to 5° C. to precipitate 54.1 g (79.9%) of an off white solid.

### Synthesis of 11-[4-(p-tolyl)phenoxy]undecan-1-ol

NaH (11.3 g, 283 mmol) was added to a 2-L, 3 neck RBF fitted with mechanical stirrer and internal thermometer, evacuated, and purged with nitrogen. The solid NaH was washed with 200 mL heptane, and the heptane decanted. This was repeated. DMF (600 mL) was then added. 4′-Methyl[1,1′-biphenyl]-4-ol (53.0 g, 287 mmol) was then added in portions under heavy flow of nitrogen, keeping bubbling under control. The material was then heated to 80° C. until bubbling stopped. KI (5 g, 30 mmol) and 11-bromo-1-undecanol (69.0 g, 275 mmol) was then added, and the mixture was heated to 80° C. The mixture was stirred 12 hours and then heat was removed. After cooling to 60° C., 300 mL ethyl acetate was added and mixed, and the mixture was poured into a separatory funnel containing 500 mL of 5% aqueous KOH and 300 mL heptane. The mixture was shaken, and the aqueous phase extracted with 500 mL of 50% ethyl acetate in heptane. The combined organic extracts were then washed with 500 mL 5% aqueous KOH solution, followed by 500 mL water, dried over MgSO₄, and 30 g of silica gel was added and the mixture stirred for 5 minutes then filtered. The solution was concentrated by rotary evaporation, and the resulting solids were recrystallized from ethanol to give 86.21 g (88.5%) of a white solid.

### Synthesis of 11-[4-(p-tolyl)phenoxy]undecyl prop-2-enoate (M4)

11-[4-(p-Tolyl)phenoxy]undecan-1-ol (85.0 g, 240 mmol) was charged in a 2-L, 3 necked RBF fitted with internal thermometer, addition funnel, magnetic stirrer, and nitrogen inlet. Nitrogen was blanketed over the material. Dichloromethane (1250 mL) was then added. Acryloyl chloride (28 g, 309 mmol) was then added to the suspension, which was then cooled to ˜4° C. in an ice bath. N,N-diisopropylethylamine (34 g, 263, mmol) was then added dropwise to the mixture, keeping the temperature below 10° C. The material was stirred 15 minutes and then allowed to warm to room temperature. An additional aliquot of N,N-diisopropylethylamine (4 g, 21 mmol) and acryloyl chloride (2 g, 22 mmol) were added, and the mixture was allowed to stir overnight at room temperature. TLC analysis indicated the disappearance of the starting material. The mixture was then poured into 500 mL of 5% aqueous KOH, and shaken in a separatory funnel. The aqueous fraction was extracted with 200 mL dichloromethane, and then the combined organic fractions were washed with 500 mL 1M HCl, followed by 500 mL deionized water. The organic fraction was then diluted by 800 mL heptane, dried over MgSO₄, and filtered over a short plug of silica gel. The solvent was then evaporated by rotary evaporation, and the resulting solid was recrystallized from heptane to give 87.5 g (89%) of a white crystalline solid; m. p.=70.0-72.5° C.

### Preparation of 11-(4-n-butylphenoxy)undecan-1-ol

NaH (6.30 g, 158 mmol) was added to a 1-L, 3 neck RBF fitted with internal thermometer and magnetic stirrer. The flask was purged with nitrogen running at 1 L/min for 2 minutes. The solid NaH was then washed with 400 mL heptane, and the heptane decanted under heavy flow of nitrogen. DMF (250 mL) was then added, and the mixture was purged with nitrogen gas and then was heated to 40° C. 4-n-Butylphenol (25.0 g, 166 mmol) was dissolved in 20 g of DMF and the solution added dropwise, keeping bubbling under control. The mixture was then heated to 90° C. and KI (5 g, 30 mmol) was added. This was stirred 15 minutes. 11-bromo-1-undecanol (38.0 g, 151 mmol) was then added. This mixture was stirred at 90° C. for 16 hours. The mixture was then cooled to 60° C. and was poured into a separatory funnel containing 300 mL warm (˜50° C.) 5% aqueous potassium hydroxide and 500 mL 30% ethyl acetate in heptane. The mixture was shaken and separated. The organic phase was again washed with 300 mL warm (˜50° C.) 5% aqueous potassium hydroxide, followed by 500 mL (˜50° C.) warm water. The organic phase was then filtered through a short plug of silica gel (˜2″ high×2.75″ diameter) and evaporated This was recrystallized from acetonitrile to give 42.8 g (88.3%) of a white crystalline solid.

### Preparation of 11-(4-butylphenoxy)undecyl prop-2-enoate (M5)

A 1-L, 3 neck RBF with nitrogen inlet, internal thermometer, magnetic stirrer, and addition funnel was charged with 11-(4-butylphenoxy)undecan-1-ol (29.1 g, 140 mmol) and 400 mL of dichloromethane was added, and cooled to 5° C. in an ice bath. Acryloyl chloride (15.0 g, 166 mmol) was then added, and then N,N-diisopropylethylamine (20.0 g, 155 mmol) was added dropwise via addition funnel, keeping the reaction mixture below 10° C. The mixture was stirred at 5° C. for one hour and then allowed to warm to room temperature overnight. The mixture was washed with 500 mL 5% aqueous NaOH, then 500 mL 10% concentrated HCl in water, and then 500 mL 0.1% NaCl in water. The organic fraction was dried over MgSO₄ and an equivalent volume of heptane was added. The organic phase was filtered through a short plug of silica gel, and then the dichloromethane was evaporated via rotary evaporation, and the residue recrystallized from heptane to give 14.2 g (28.9%) of a white solid; m. p.=22°-24° C.

### Preparation of 11-(4-ethylphenoxy)undecan-1-ol

NaH (12.8 g, 320 mmol) was added to a 1-L, 3 neck RBF fitted with internal thermometer and magnetic stirrer. The flask was purged with nitrogen running at 1 L/min for 5 min. The solid NaH was then washed with 400 mL heptane, and the heptane decanted under heavy flow of nitrogen. DMF (500 mL) was then added, and the mixture was purged with nitrogen gas and then was heated to 40° C. 4-ethylphenol (41.9 g, 343 mmol) was added as a solid in portions, keeping bubbling under control. The mixture was then heated to 80° C. and KI (5 g, 30 mmol) was added. This was stirred 15 minutes. 11-Bromoundecanol (75.0 g, 299 mmol) was then added, and this mixture was stirred at 90° C. for 16 hours. The mixture was then cooled to 60° C. and was poured into a separatory funnel containing 500 mL warm (˜50° C.) 5% aq. potassium hydroxide and 500 mL 30% ethyl acetate in heptane. The mixture was shaken, separated, and then the aqueous phase was extracted with 300 mL 30% ethyl acetate in heptane. The combined organic extracts were again washed with 500 mL warm (˜50° C.) 5% aqueous potassium hydroxide, followed by 500 mL (˜50° C.) warm water. The organic phase was then filtered through a short plug of silica gel and evaporated to yield 87.1 g (99.8%) of a slightly yellow liquid that solidified on standing.

### Preparation of 11-(4-ethylphenoxy)undecyl prop-2-enoate (M6)

A 1-L, 3 neck RBF with nitrogen inlet, internal thermometer, magnetic stirrer, and addition funnel was charged with 11-(4-ethylphenoxy)undecan-1-ol (87.1 g, 298 mmol) and 500 mL of dichloromethane was added, and cooled to 5° C. in an ice bath. Acryloyl chloride (33.0 g, 364 mmol) was then added, and then N,N-diisopropylethylamine (43.0 r. 332 mmol) was added dropwise via addition funnel, keeping the reaction mixture below 10° C. The mixture was stirred at 5° C. one hour and then allowed to warm to room temperature overnight. The mixture was washed with 500 mL 5% aqueous NaOH, then 500 mL 10% concentrated HCl in water, and then 500 mL 0.1% NaCl in water. The organic fraction was dried over MgSO₄ and an equivalent volume of heptane was added. The organic phase was filtered through a short plug of silica gel, and then the dichloromethane was evaporated via rotary evaporation, and the residue recrystallized from heptane to give 64.0 g (62.0%) of a white solid; m. p.=27-28° C.

### Preparation of 4-(dodecyloxy)-benzenemethanol

NaH (13.5 g, 338 mmol) was added to a 1-L, 3 neck RBF fitted with internal thermometer and magnetic stirrer. The flask was purged with nitrogen running at 1 L/min. The solid NaH was then washed with 400 mL heptane, and the heptane decanted under heavy flow of nitrogen. DMF (500 mL) was then added, and the mixture was purged with nitrogen gas and then was heated to 40 C. 4-hydroxybenzyl alcohol (45.0 g, 363 mmol) was added as a solid in portions, keeping bubbling under control. The mixture was then heated to 80° C. and KI (5 g, 30 mmol) was added. This was stirred 15 minutes. 1-bromododecane (75.0 g, 301 mmol) was then added, and the exothermic reaction warmed the solution to about 95° C. This was stirred at 90° C. for 16 hours. The mixture was then cooled to 60° C. and was poured into a separatory funnel containing 500 mL warm (˜50° C.) 5% aqueous sodium hydroxide and 500 mL 40% ethyl acetate in heptane. The mixture was shaken, separated, and then the aqueous phase was extracted with 300 mL 40% ethyl acetate in heptane. The combined organic extracts were again washed with 500 mL warm (˜50° C.) 5% sodium hydroxide, followed by 500 mL (˜50° C.) warm water. The organic phase was then filtered through a short plug of silica gel and evaporated to yield 82.1 g (93.3%) of a white solid.

### Preparation of (4-dodecoxyphenyl)methyl prop-2-enoate (M7)

A 1-L, 3 neck round bottom flask with nitrogen inlet, internal thermometer, magnetic stirrer, and addition funnel was charged with 4-(dodecyloxy)benzenemethanol (60.0 g, 205 mmol) and 500 mL of dichloromethane was added, and cooled to 5° C. in an ice bath. Acryloyl chloride (23.3 g, 257 mol) was then added, and then N,N-diisopropylethylamine (30 g, 232 mmol) was added dropwise via addition funnel, keeping the reaction mixture below 10° C. The mixture was stirred at 0° C. for two hours and then stirred overnight. The mixture was washed with 500 mL 5% NaOH, then 500 mL 10% HCl, and then 500 mL deionized water. The organic fraction was dried over MgSO₄ and an equivalent volume of heptane was added. The organic phase was filtered through a short plug of silica gel, and then the dichloromethane was removed via rotary evaporation, and the materials were recrystallized from heptane to give a 38.0 g (53.5%) of a white solid; m. p.=28-29° C.

### Preparation of 9-(4-methylphenoxy)nonan-1-ol

NaH (13.5 g, 338 mmol) was added to a 1-L, 3 neck RBF fitted with internal thermometer and magnetic stirrer. The flask was purged with nitrogen running at 1 L/min for 5 minutes. The solid NaH was then washed with 400 mL heptane, and the heptane decanted under heavy flow of nitrogen. DMF (500 mL) was then added, and the mixture was purged with nitrogen gas and then was heated to 40° C. p-cresol (39.0 g, 360 mmol) was added as a solid in portions, keeping bubbling under control. The mixture was then heated to 80° C. and KI (5 g, 30 mmol) was added. This was stirred 15 minutes. 9-bromo-1-nonanol (67.0 g, 300 mmol) was then added, and the mixture temperature rose to about 95° C. This was allowed to cool to 90° C. and stirred for 16 hours. The mixture was then cooled to 60° C. and was poured into a separatory funnel containing 500 mL warm (˜50° C.) 5% aq. sodium hydroxide and 500 mL 40% ethyl acetate in heptane. The mixture was shaken, separated, and then the aqueous phase was extracted with 300 mL 40% ethyl acetate in heptane. The combined organic extracts were again washed with 500 mL warm (˜50° C.) 5% sodium hydroxide, followed by 500 mL (˜50° C.) warm water. The organic phase was then filtered through a short plug of silica gel and evaporated to yield 73.73 g (98.1%) of a slightly yellow liquid that solidified on standing.

### Preparation of 9-(4-methylphenoxy)nonyl prop-2-enoate (M8)

A 1-L, 3 neck RBF with nitrogen inlet, internal thermometer, magnetic stirrer, and addition funnel was charged with 9-(4-methylphenoxy)nonan-1-ol (73.7 g, 294 mmol) and 500 mL of dichloromethane was added, and cooled to 5° C. in an ice bath. Acryloyl chloride (33.0 g, 364 mmol) was then added, and then N,N-diisopropylethylamine (43.0 g, 332 mmol) was added dropwise via addition funnel, keeping the reaction mixture below 10° C. The mixture was stirred at 5° C. one hour and then allowed to warm to room temperature overnight. The mixture was washed with 500 mL 5% aqueous NaOH, then 500 mL 10% concentrated HCl in water, and then 500 mL 0.1% NaCl in water. The organic fraction was dried over MgSO₄ and an equivalent volume of heptane was added. The organic phase was filtered through a short plug of silica gel, and then the dichloromethane was evaporated via rotary evaporation, and the residue recrystallized from heptane to give 70.4 g (78.5%) of a white solid; m. p.=33.5-34.5° C.

### Preparation of 11-(3,4-dimethylphenoxy)undecan-1-ol

NaH (12.7 g, 318 mmol) was added to a 2-L, 3 neck RBF, evacuated, and purged with nitrogen. The solid NaH was washed with 200 mL heptane, and the heptane decanted. This was repeated. DMF (700 mL) was then added. 3,4-dimethylphenol (40.3 g, 330 mmol) was then added in portions under heavy flow of nitrogen, keeping bubbling under control. The material was then heated to 80° C. until bubbling stopped. KI (5 g, 30 mmol) and 11-bromo-1-undecanol (75.0 g, 299 mmol) was then added, and the mixture was heated to 80° C. The mixture was stirred 12 hours and then heat was removed. After cooling to room temperature, the mixture was poured into a separatory funnel containing 500 mL of warm (˜50° C.) 5% aqueous KOH and 500 mL heptane. The mixture was shaken, and the aqueous phase extracted with 500 mL heptane. The combined organic extracts were then washed with 500 mL warm (˜50° C.) 5% aqueous KOH solution, followed by 500 mL water, dried over MgSO₄, and 30 g of silica gel was added and the mixture stirred for 5 minutes then filtered. The solution was concentrated by rotary evaporation to give 83.5 g (95.6%) of an oil that solidified on standing.

### Preparation of 11-(3,4-dimethylphenoxy)undecyl prop-2-enoate (M9)

11-(3,4-Dimethylphenoxy)undecan-1-ol (82.5 g, 282 mmol) was charged in a 2-L, 3 necked RBF fitted with internal thermometer, addition funnel, magnetic stirrer, and nitrogen inlet. Nitrogen was blanketed over the material. Dichloromethane (750 mL) was then added, and the alcohol was allowed to dissolve. Acryloyl chloride (32.0 g, 353 mmol) was then added to the solution, which was then cooled to ˜4° C. in an ice bath. N,N-Diisopropylethylamine (40.5 g, 313, mmol) was then added dropwise to the mixture, keeping the temperature below 10 C. The material was stirred 15 minutes and then allowed to warm to room temperature. TLC analysis (20% ethyl acetate in heptane) was performed, and this showed some starting material remaining. Additional N,N-diisopropylethylamine (4 g, 21 mmol) and acryloyl chloride (2 g, 22 mmol) were added, and the mixture was allowed to stir overnight at room temperature. TLC analysis indicated the disappearance of the starting material. The mixture was then poured into 500 mL of 5% aqueous KOH, and shaken in a separatory funnel. The aqueous fraction was extracted with 200 mL dichloromethane, and then the combined organic fractions were washed with 500 mL 1M HCl, followed by 500 mL deionized water. The organic fraction was then diluted by 800 mL heptane, dried over MgSO₄, and filtered over a short plug of silica gel. The solvent was then evaporated by rotary evaporation, and the resulting solid was recrystallized from heptane to give 75.1 g (76.9%) of a white solid; m. p.=35.5-36.0° C.

### Preparation of 11-(4-chlorophenyl)sulfanylundecan-1-ol

NaH (8.40 g, 210 mmol) was added to a 1-L, 3 neck RBF fitted with internal thermometer, and magnetic stirrer. The flask was evacuated and backfilled with nitrogen 3×. The solid NaH was then washed with 200 mL heptane, and the heptane decanted under heavy flow of nitrogen. This was repeated. DMF (650 mL) was then added, and the mixture was sparged with nitrogen gas for 20 minutes and then heated to 60° C. 4-Chlorobenzenethiol (30.5 g, 211 mmol) was then added in portions under heavy flow of nitrogen, keeping bubbling under control. The material was then heated to 80° C. until bubbling stopped. KI (5 g, 30 mmol) and 11-bromo-1-undecanol (50.0 g, 199 mmol) was then added, and the mixture was stirred at 80° C. for 16 hours. After cooling to room temperature, the mixture was poured into a separatory funnel containing 500 mL of warm (˜45° C.) 5% aqueous KOH and 500 mL 30% ethyl acetate in heptane. The mixture was shaken, and each aqueous phase was further extracted with 300 mL 30% ethyl acetate in heptane. The combined organic extracts were washed with warm (˜45° C.) 500 mL 5% aqueous KOH solution, followed by warm 500 mL (˜45° C.) water, and dried over MgSO₄. The mixture was then filtered over a short plug of silica gel and concentrated by rotary evaporation to give 61.46 g (98.0%) of an oil that solidified on standing.

### Preparation of 11-(4-chlorophenyl)sulfanylundecylprop-2-enoate (M10)

11-(4-Chlorophenyl)sulfanylundecan-1-ol (61.0 g, 194 mmol) was charged in a 1-L, 3 necked RBF fitted with internal thermometer, addition funnel, magnetic stirrer, and nitrogen inlet. Nitrogen was blanketed over the material. Dichloromethane (650 mL) was then added, and the alcohol was allowed to dissolve. Acryloyl chloride (22.0 g, 243 mmol) was then added to the solution, which was then cooled to ˜4° C. in an ice bath. N,N-Diisopropylethylamine (31.0 g, 240 mmol) was then added dropwise to the mixture, keeping the temperature below 10° C. The material was stirred 15 minutes and then allowed to warm to room temperature and stirred overnight. TLC analysis (20% ethyl acetate in heptane) indicated the disappearance of the starting material. The mixture was then poured into 500 mL of 5% aqueous KOH and shaken in a separatory funnel. The aqueous fraction was extracted with 200 mL dichloromethane, and then the combined organic fractions were washed with 500 mL 1M HCl, followed by 500 mL deionized water. The organic phase was dried over MgSO₄, filtered, and 700 mL heptane was added to the filtrate. This was then filtered over a short plug of silica gel. The solvent was then evaporated by rotary evaporation, and the residue was recrystallized from heptane to give 42.57 g (59.6%) of a white crystalline solid; m. p.=37.5-38.5° C.

### Preparation of 11-phenoxyundecan-1-ol

NaH (12.5 g, 313 mmol) was added to a 1-L, 3 neck RBF fitted with internal thermometer and magnetic stirrer. The flask was purged with nitrogen running at 1 L/min for 5 minutes. The solid NaH was then washed with 400 mL heptane, and the heptane decanted under heavy flow of nitrogen. DMF (500 mL) was then added, and the mixture was purged with nitrogen gas and then was heated to 40° C. Phenol (32.5 g, 345 mmol) was added as a solid in portions, keeping bubbling under control. The mixture was then heated to 80° C. and KI (5 g, 30 mmol) was added. This was stirred 15 minutes. 11-bromo-1-undecanol (75.0 g, 299 mmol) was then added and the mixture was stirred at 90° C. for 16 hours. The mixture was then cooled to 60° C. and was poured into a separatory funnel containing 500 mL warm (˜50° C.) 5% aq. sodium hydroxide and 500 mL 30% ethyl acetate in heptane. The mixture was shaken, separated, and then the aqueous phase was extracted with 300 mL 30% ethyl acetate in heptane. The combined organic extracts were again washed with 500 mL warm (˜50° C.) 5% sodium hydroxide, followed by 500 mL (˜50° C.) warm water. The organic phase was then dried over MgSO₄ and filtered through a short plug of silica gel and evaporated to yield 75.0 g (95.1%) of a slightly yellow liquid that solidified on standing.

### Preparation of 11-phenoxyundecyl prop-2-enoate (M1)

A 1-L, 3 neck RBF with nitrogen inlet, internal thermometer, magnetic stirrer, and addition funnel was charged with 11-phenoxyundecan-1-ol (75.0 g, 283 mmol) and 500 mL of dichloromethane was added, and the mixture was cooled to 5° C. in an ice bath. Acryloyl chloride (33.0 g, 364 mmol) was then added, and then N,N-diisopropylethylamine (43.0 g, 332 mmol) was added dropwise via addition funnel, keeping the reaction mixture below 10° C. The mixture was stirred at 5° C. one hour and then allowed to warm to room temperature overnight. The mixture was then washed with 500 mL 5% aqueous NaOH, then 500 mL 10% concentrated HCl in water, and then 500 mL 0.1% NaCl in water. The organic fraction was dried over MgSO₄ and an equivalent volume of heptane was added. The organic phase was filtered through a short plug of silica gel, and then the dichloromethane was evaporated via rotary evaporation, and the residue recrystallized from heptane to give 72.6 g (80.4%) of a white solid; m. p.=40.5-42.5° C.

### Preparation of (4-octadecoxyphenyl)methanol

NaH (13.5 g, 338 mmol) was added to a 1-L, 3 neck RBF fitted with internal thermometer and magnetic stirrer. The flask was purged with nitrogen running at 1 L/min for 5 min. The solid NaH was then washed with 400 mL heptane, and the heptane decanted under heavy flow of nitrogen. DMF (500 mL) was then added, and then was heated to 40° C. 4-hydroxybenzyl alcohol (45.0 g, 363 mmol) was added as a solid in portions, keeping bubbling under control. The mixture was then heated to 80° C. and then KI (5 g, 30 mmol) was added. This was stirred 15 minutes. 1-Bromooctadecane (100 g, 300 mmol) was then added, and this mixture was stirred at 90° C. for 16 hours. The mixture was then cooled to 60° C. and was poured into a separatory funnel containing 500 mL warm (˜50° C.) 5% aq. sodium hydroxide and 500 mL 40% ethyl acetate in heptane. The mixture was shaken, separated, and then the aqueous phase was extracted with 300 mL warm 40% ethyl acetate in heptane. The combined organic extracts were again washed with 500 mL warm (˜50° C.) 5% sodium hydroxide, followed by 500 mL (˜50° C.) warm water. 500 mL ethyl acetate was added to the organic phase, and this was heated to boiling, and anhydrous MgSO₄ was carefully added to dry the organic phase. This mixture was filtered hot and the filtrate was cooled in a −20° C. freezer to precipitate the solid product. The product was filtered and dried under reduced pressure to give 92.0 g (81.5%) of an off white solid.

### Preparation of (4-octadecoxyphenyl)methyl prop-2-enoate (M12)

A 1-L, 3 neck round bottom flask with addition funnel, nitrogen inlet, internal thermometer, and magnetic stirrer was charged with 4-(octadecyloxy)benzenemethanol (60.0 g, 159 mmol) and 650 mL of dichloromethane was added. Acryloyl chloride (17.5 g, 193 mmol) was then added to the room-temperature suspension, and then N,N-diisopropylethylamine (22.5 g, 174 mmol) was added dropwise via addition funnel keeping the temperature below 30° C. The mixture was stirred at room temperature overnight. The mixture was washed with 500 mL 5% NaOH, then 500 mL 10% HCl, and then 500 mL deionized water. The organic fraction was dried over MgSO₄ and an equivalent volume of heptane was added. The organic phase was filtered through a short plug of silica gel, and then the dichloromethane was removed via rotary evaporation, and the materials were recrystallized from heptane to give 55.8 g (81.3%) of a white solid. m. p.=48-49° C.

### Preparation of 4-(4-tertbutylphenyl)phenol

Sodium carbonate (71.0 g, 670 mmol) and water (1 L) were mixed in a 2-L, 3 neck RBF fitted with internal thermometer and mechanical stirrer, and then 4-tertbutylphenylboronic acid (40.3 g, 226 mmol), 4-iodophenol (50.0 g, 227 mmol), and 1.5 g of 10% Pd/C were added. The mixture was heated to 90° C. for 2 hours, and a precipitate occurred. The mixture was cooled to ˜60° C. and was acidified by the dropwise addition of concentrated hydrochloric acid until the pH was below 4. The mixture was then cooled to room temperature and filtered. The solid was taken up in ˜1000 mL methanol and heated to boiling. This was filtered hot to remove Pd/C, and the filtrate was brought to boil. Water (approximately 500 mL) was added until a precipitate remained visible after thorough mixing, and then enough methanol was added to just dissolve the solid again at boiling. The mixture was cooled to ˜5° C. overnight in a refrigerator and filtered to give 50.6 (99.0%) of an off white solid.

### Preparation of 11-[4-(4-tert-butylphenyl)phenoxy]undecan-1-ol

NaH (4.65 g, 116 mmol) was added to a 500 mL, 3 neck RBF fitted with internal thermometer, and magnetic stirrer. The flask was purged with nitrogen for 5 minutes at 1 LPM. The solid NaH was then washed with 200 mL heptane, and the heptane decanted under heavy flow of nitrogen. DMF (250 mL) was then added, then the mixture was heated to 40° C. 4-(4-tertbutylphenyl)phenol (25.0 g, 110 mmol) was then added in portions under heavy flow of nitrogen, keeping bubbling under control. The material was then heated to 80° C. until bubbling stopped. NaI (2.5 g, 17 mmol) and 11-bromo-1-undecanol (27.5 g, 109 mmol) was then added, and the mixture was stirred at 80° C. for 16 hours. After cooling to room temperature, the mixture was poured into a separatory funnel containing 500 mL of warm (˜45° C.) 5% aqueous KOH and 500 mL 40% ethyl acetate in heptane. The mixture was shaken, and each aqueous phase was further extracted with 300 mL 40% ethyl acetate in heptane. The combined organic extracts were washed with warm (˜45° C.) 500 mL 5% aqueous KOH solution, followed by warm (˜45° C.) 500 mL water, and dried over MgSO₄ and filtered through a short plug of silica gel and the solvent evaporated to yield 40.5 g (93.3%) of a white solid.

### Synthesis of 6-[4-(4-tert-butylphenyl)phenoxy]hexyl prop-2-enoate (M13)

11-[4-(4-tert-Butylphenyl)phenoxy]hexan-1-ol (31.2 g, 95.4 mmol) was charged in a 1-L, 3 neck RBF fitted with internal thermometer, addition funnel, magnetic stirrer, and nitrogen inlet. Nitrogen was blanketed over the material. Dichloromethane (500 mL) was then added, and then acryloyl chloride (10.5 g, 116 mmol) was added. The mixture was then cooled to ˜4° C. in an ice bath. N,N-diisopropylethylamine (14.0 g, 108 mmol) was then added dropwise to the mixture, keeping the temperature below 10° C. The material was stirred 15 minutes and then allowed to warm to room temperature and stirred overnight. The mixture was then poured into 500 mL of 5% aqueous KOH and shaken in a separatory funnel. The aqueous fraction was extracted with 200 mL dichloromethane, and then the combined organic fractions were washed with 500 mL 1M HCl, followed by 500 mL deionized water. The organic phase was dried over MgSO₄, filtered, and 700 mL heptane was added to the filtrate. This was then filtered over a short plug of silica gel. The solvent was then evaporated by rotary evaporation, and the residue was recrystallized from heptane to give 30.5 g (83.9%) of a white solid; m. p.=59.0-60.5° C.

### Preparation of 11-[4-(4-tert-butylphenyl)phenoxy]undecyl prop-2-enoate (M14)

11-[4-(4-tert-Butylphenyl)phenoxy]undecan-1-ol (40.5 g, 102 mmol) was charged in a 1-L, 3 neck RBF fitted with internal thermometer, addition funnel, magnetic stirrer, and nitrogen inlet. Nitrogen was blanketed over the material. Dichloromethane (500 mL) was then added, and then acryloyl chloride (11.5 g, 125 mmol) was added. The mixture was then cooled to ˜4° C. in an ice bath. N,N-diisopropylethylamine (15.0 g, 116 mmol) was then added dropwise to the mixture, keeping the temperature below 10° C. The material was stirred 15 minutes and then allowed to warm to room temperature and stirred overnight. The mixture was then poured into 500 mL of 5% aqueous KOH and shaken in a separatory funnel. The aqueous fraction was extracted with 200 mL dichloromethane, and then the combined organic fractions were washed with 500 mL 1M HCl, followed by 500 mL deionized water. The organic phase was dried over MgSO₄, filtered, and 700 mL heptane was added to the filtrate. This was then filtered over a short plug of silica gel. The solvent was then evaporated by rotary evaporation, and the residue was recrystallized from heptane to give 34.0 g (73.9%) of a white solid; m. p.=61.5-63.5° C.

### Preparation of [4-hexyloxy)phenyl]methanol

NaH (13.5 g, 338 mmol) was added to a 1-L, 3 neck RBF fitted with internal thermometer, and magnetic stirrer. The flask was purged with nitrogen running at 1 L/min for 5 min. The solid NaH was then washed with 400 mL heptane, and the heptane decanted under heavy flow of nitrogen. This was repeated. DMF (500 mL) was then added, and the mixture was purged with nitrogen gas and then was heated to 40° C. 4-hydroxybenzyl alcohol (45.0 g, 363 mmol) was added as a solid in portions, keeping bubbling under control. The mixture was then heated to 80° C. and KI (5 g, 30 mmol) was added. This was stirred 15 minutes. 1-bromohexane (50.0 g, 303 mmol) was then added. This was stirred at 90° C. for 16 hours. The mixture was then cooled to 60° C. and was poured into a separatory funnel containing 500 mL warm (˜50° C. 5% aq. sodium hydroxide and 500 mL 40% ethyl acetate in heptane. The mixture was shaken, separated, and then the aqueous phase was extracted with 300 mL 40% ethyl acetate in heptane. The combined organic extracts were again washed with 500 mL warm (˜50° C.) 5% sodium hydroxide, followed by 500 mL (˜50° C.) warm water. The organic phase was then filtered through a short plug of silica gel and evaporated to yield 50.2 g (79.6%) g of liquid which solidified on standing.

### Preparation of (4-hexoxyphenyl)methyl prop-2-enoate (M15)

A 1-L, 3 neck round bottom flask with nitrogen inlet, internal thermometer, magnetic stirrer, and addition funnel was charged with [4-(hexyloxy)phenyl]methanol (29.1 g, 140 mmol) and then 500 mL of dichloromethane was added, and the mixture was cooled to 5° C. in an ice bath. Acryloyl chloride (16.0 g, 177 mol) was then added, and then N,N-diisopropylethylamine (20.0 g, 155 mmol) was added dropwise via addition funnel, keeping the reaction mixture below 10° C. The mixture was stirred at 5° C. one hour and then stirred overnight. The mixture was washed with 500 mL 5% NaOH, then 500 mL 10% HCl, and then 500 mL deionized water. The organic fraction was dried over MgSO₄ and an equivalent volume of heptane was added. The organic phase was filtered through a short plug of silica gel, and then the solvent was evaporated via rotary evaporation to give 23.1 g (63.0%) of a light yellow/orange colored oil.

### Preparation of 11-(4-tert-butylphenoxy)undecan-1-ol

A 2-L, 3 neck RBF was fitted with internal thermometer and magnetic stir bar and evacuated and backfilled with nitrogen 3×. NaH (17.5 g, 438 mmol) was added under nitrogen, and 200 mL heptane was added and stirred 5 minutes, and the heptane was decanted under heavy flow of nitrogen. Dimethylformamide (800 mL) was then added. 4-tertbutylphenol (75.0 g, 499 mmol) was added slowly in portions under strong stirring and ˜1-Lpm flow of nitrogen. This was stirred for 1 hour until bubbling stopped. Potassium iodide (5 g, 40 mmol) and 11-bromo-1-undecanol (100 g, 398 mmol) were added and the mixture was heated to 70° C. for 1 hour and then the temperature was raised to 80° C. for 16 hours. The reaction mixture was then cooled to 40° C. and poured into a separatory funnel containing 400 mL heptane and 400 mL of 2.5% aqueous KOH. The mixture was separated, and the aqueous phase was extracted with 400 mL heptane and again with 200 mL heptane. The combined heptane extracts were washed with 400 mL of 3.1% aqueous KOH, followed by 400 mL deionized water. The organic phase was then dried over MgSO₄, and 45 g of Silica gel was added and the mixture stirred 10 minutes. This was then filtered and evaporated to yield 105 g (82.2%) of a slightly yellow oil that solidified on standing.

### Preparation of 11-(4-tert-butylphenoxy)undecyl prop-2-enoate (M16)

A 2-L, 3 neck RBF was fitted with internal thermometer, addition funnel, and magnetic stir bar was evacuated and backfilled with nitrogen 3×. This was then charged with 11-(4-tert-butylphenoxy)-undecan-1-ol (93.6 g, 292 mmol), dichloromethane (900 mL), and triethylamine (60.0 g, 592 mmol), and then cooled to ˜5° C. in an ice bath. Acryloyl chloride (28 g, 309 mmol) was then added dropwise, keeping the temperature below 10° C. This was stirred 15 minutes, and TLC was performed (25% ethyl acetate in heptane) and it was found that some alcohol starting material remained. An additional portion of acryloyl chloride (4.0 g. 44 mmol) was added dropwise, and stirred an additional 30 minutes. TLC showed complete consumption of the starting alcohol. The mixture was then warmed to room temperature, stirred for 1 hour, and an additional charge of triethylamine (30.0 g, 2% mmol) was added. This was stirred 2 more hours, and then the dichloromethane was removed by rotary evaporation. The material was taken up in 2000 mL of heptane, filtered, and further filtered through a plug of silica gel. The silica gel was washed with 5% ethyl acetate in heptane. The combined filtrate was then concentrated to about 1300 mL, and washed with 300 mL 10% aqueous NaCl containing 10 mL of concentrated HCl. The aqueous phase was then extracted with 200 mL heptane. The combined organic phase was dried over MgSO₄, and 30 g silica gel was added. The mixture was stirred 10 minutes and then filtered and concentrated to give 97.3 g (88.9%) of an orange oil. The oil solidified on standing; m. p.=27.5-28.5° C.

### Preparation of Master Batches (MB)

MB-1: 0.46 g Vazo 67 was added to 410.55 g of ethyl acetate and mixed until the solid was dissolved.

MB-2: 0.38 g of Vazo 67 was added to 302.51 g of ethyl acetate and mixed until the solid was dissolved.

MB-3: 232.7 g of ethyl acetate was added to 0.30 g Vazo 67 and 3.00 g AA until the solid was dissolved.

MB-4: 0.045 g of Vazo 67 was added to 8.9 g of ethyl acetate and 8.9 g of xylenes and mixed until the solid was dissolved.

MB-5: 0.53 g of Vazo 67 was added to a solution of 5.4 g of AA in 418.87 g of ethyl acetate and mixed until the solid was dissolved.

MB-6: 0.35 g of Vazo 67 was added to a solution of 7.2 g of AA in 275.64 g of ethyl acetate and mixed until the solid was dissolved.

MB-7: 0.11 g of Vazo 67 was added to a solution of 1.2 g of AA in 93.08 g of ethyl acetate and mixed until the solid was dissolved.

### General Polymerization Procedure

Copolymer samples were prepared as follows. The components listed in the tables were charged to a (4 oz, 120 mL) Boston round glass heavy weight bottle in amounts reported in Tables 2-4 below. The bottle was purged with nitrogen gas (1.2 liters per minute for 90 seconds), then sealed with a polytetrafluoroethylene-lined metal cap. The cap was wrapped with electrical tape to secure it before placing the bottle in a safety cage with lid, using sponges to fill unoccupied space in the cage. Finally, the cage was secured with retaining bars in a water-filled launderometer tank at 65° C. After approximately 22 hours, the bottle was removed from the launderometer. Tables 4, 5 and 6, below, report Example copolymer compositions.

### General Procedure for Coating Films

Polymer solutions from above were diluted 1 g of solution to 5 grams of 80/20 wt./wt. xylenes and 1-methoxy-2-propanol, and coated onto a 3 mil PET (polyethylene terephthalate) substrate with a #20 Mayer rod (0.002 inch nominal wet coating thickness), followed by drying for 2 minutes at 115° C. in an oven.

Tables 2-6 collectively report amounts in grams of monomer components used to make copolymers EX-1 to EX-24 and CE-A to CE-T.

TABLE 2

| | COPOLYMER | | | | | | | |
|---|---|---|---|---|---|---|---|---|
| MONOMER | CE-A | EX-1 | EX-2 | EX-3 | EX-4 | EX-5 | EX-6 | EX-7 |
| MB-1 | 35.74 | 35.74 | 35.74 | 35.74 | 35.74 | 35.74 | 35.74 | 35.74 |
| HPA | | | | 4 | 2 | 2 | 2 | 2 |
| AA | 1.2 | 0.4 | 0.8 | 0.8 | 0.4 | 1.2 | 0.8 | 0.8 |
| M1 | | 13.10 | 6.35 | 4.35 | 5.55 | 5.15 | 5.35 | 5.35 |
| ODA | 12.30 | | 6.35 | 4.35 | 5.55 | 5.15 | 5.35 | 5.35 |

TABLE 3

| | COPOLYMER | | | | | | |
|---|---|---|---|---|---|---|---|
| MONOMER | EX-8 | EX-9 | EX-10 | CE-B | EX-11 | CE-C | EX-12 |
| MB-2 | 23.3 | 23.3 | 23.3 | 23.3 | 23.3 | 23.3 | 23.3 |
| AA | 0.1 | 0.2 | 0.5 | 1 | | | |
| M1 | 9.9 | 9.8 | 9.5 | 9 | 9.9 | 9.5 | 9.5 |
| MAA | | | | | | 0.5 | |
| HPA | | | | | 0.52 | | |
| HEMA | | | | | | | 0.5 |

TABLE 4

| | COPOLYMER | | | | | | | | |
|---|---|---|---|---|---|---|---|---|---|
| MONO- | CE- | CE- | CE- | CE- | CE- | EX- | CE- | CE- | CE- |
| MER | D | E | F | G | H | 13 | I | J | K |
| MB-3 | 23.6 | 23.6 | 23.6 | 23.6 | 23.6 | 23.6 | 23.6 | 23.6 | |
| MB-4 | | | | | | | | | 17.84 |
| 2EHA | 9.7 | | | | | | | | |
| HMA | | 9.7 | | | | | | | |
| TDA | | | 9.7 | | | | | | |
| HDA | | | | 9.7 | | | | | |
| tBA | | | | | 9.7 | | | | |
| M3 | | | | | | 9.7 | | | |
| M4 | | | | | | | 9.7 | | |
| M2 | | | | | | | | 9.7 | |
| M1 | | | | | | | | | 7.2 |

TABLE 5

| | COPOLYMER | | | | | | | | | | |
|---|---|---|---|---|---|---|---|---|---|---|---|
| MONOMER | EX-14 | EX-15 | EX-16 | CE-L | CE-M | CE-N | CE-O | CE-P | CE-Q | CE-R | EX-17 |
| MB-5 | 23.6 | 23.6 | 23.6 | 23.6 | 23.6 | 23.6 | 23.6 | 23.6 | 23.6 | 23.6 | 23.6 |
| M5 | 9.7 | | | | | | | | | | |
| M6 | | 9.7 | | | | | | | | | |
| M7 | | | 9.7 | | | | | | | | |
| M8 | | | | 9.7 | | | | | | | |
| M9 | | | | | 9.7 | | | | | | |
| M10 | | | | | | 9.7 | | | | | |
| M11 | | | | | | | 9.7 | | | | |
| M12 | | | | | | | | 9.7 | | | |
| M13 | | | | | | | | | 9.7 | | |
| M14 | | | | | | | | | | 9.7 | |
| M15 | | | | | | | | | | | 9.7 |

TABLE 6

| | COPOLYMER | | | | | | | | |
|---|---|---|---|---|---|---|---|---|---|
| MONOMER | EX-18 | EX-19 | EX-20 | CE-S | EX-21 | CE-T | EX-22 | EX-23 | EX-24 |
| MB-6 | 23.3 | 23.3 | 23.3 | 23.3 | 23.3 | 23.3 | 23.3 | 23.3 | |
| MB-7 | | | | | | | | | 23.6 |
| M1 | 2.75 | 2.25 | 1.75 | 2 | 3 | 4.7 | | 4.7 | |
| HPA | 3.9 | 4.9 | 5.9 | 1.48 | 1.48 | | | | |
| ODA | 2.75 | 2.25 | 1.75 | 5.92 | 4.92 | | 4.7 | | |
| DDA | | | | | | 4.7 | | | |
| M8 | | | | | | | 4.7 | | |
| ODMA | | | | | | | | 4.7 | |
| M16 | | | | | | | | | 9.7 |

Table 7 reports the relative weight of monomer components present excluding the solvent and initiator (i.e., the composition of the resulting copolymer after coating and drying) for copolymers EX-1 to EX-7 and CE-A as well as the contact angles measured for water and hexadecane test fluids on coatings of the copolymers as well as DSC testing results. In Table 7, below, Examples 6 and 7 are replicates.

TABLE 7

| MONO- | RELATIVE MONOMER AMOUNT, parts by weight | | | | | | | |
|---|---|---|---|---|---|---|---|---|
| MER | CE-A | EX-1 | EX-2 | EX-3 | EX-4 | EX-5 | EX-6 | EX-7 |
| HPA | 0.0 | 0.0 | 0.0 | 29.6 | 14.8 | 14.8 | 14.8 | 14.8 |
| AA | 8.9 | 3.0 | 5.9 | 5.9 | 3.0 | 8.9 | 5.9 | 5.9 |
| M1 | 0.0 | 97.0 | 47.0 | 32.2 | 41.1 | 38.1 | 39.6 | 39.6 |
| ODA | 91.1 | 0.0 | 47.0 | 32.2 | 41.1 | 38.1 | 39.6 | 39.6 |
| CONTACT | | | | | | | | |
| ANGLE | | | | | | | | |
| H₂O θ_{Adv} | 111 | 137 | 102 | 148 | 130 | 137 | 120 | 126 |
| H₂O θ_{Rec} | 86 | 10 | 85 | 30 | 39 | 20 | 45 | 55 |
| HD θ_{Adv} | 40 | 137 | 127 | 130 | 128 | 120 | 130 | 140 |
| HD θ_{Rec} | 39 | — | — | — | — | — | — | — |
| DSC | | | | | | | | |
| Tₑᵢₘ (° C.) | | −16.7 | 25.4 | 10.4 | 22.5 | 18.8 | 22.2 | 21.7 |
| Tₚₘ (° C.) | | 1.02 | 31.5 | 25.3 | 29 | 27.5 | 28.4 | 28.6 |
| T_{efm} (° C.) | | 5.5 | 34.0 | 29.6 | 31.9 | 30.3 | 30.9 | 30.8 |
| ΔH_{f} (J/g) | | 20.3 | 36.2 | 31 | 29.2 | 29.1 | 32.4 | 33.3 |
| T_{eic} (° C.) | | −8.5 | 22.5 | 17.2 | 20.9 | 19.5 | 20.3 | 20.6 |
| T_{pc} (° C.) | | 11.4 | 21.5 | 13.7 | 19.7 | 17.7 | 19.2 | 19.4 |
| ΔH_{c} (J/g) | | 23 | 35.5 | 30.6 | 31.9 | 30.3 | 34.2 | 32.0 |

Table 8, below, reports the relative weight of monomer components present excluding the solvent and initiator (i.e., the composition of the resulting copolymer after coating and drying) for copolymers EX-8 to EX-12, CE-B, and CE-C as well as the contact angles measured for water and hexadecane test fluids on coatings of the copolymers as well as DSC testing results.

TABLE 8

| | RELATIVE MONOMER AMOUNT, parts by weight | | | | | | |
|---|---|---|---|---|---|---|---|
| MONOMER | EX-8 | EX-9 | EX-10 | CE-B | EX-11 | CE-C | EX-12 |
| HPA | | | | | 5.0 | | |
| AA | 1.0 | 2.0 | 5.0 | 10.0 | | | |
| M1 | 99.0 | 98.0 | 95.0 | 90.0 | 95.0 | 95.0 | 95.0 |
| MAA | | | | | | 5.0 | |
| HEMA | | | | | | | 5.0 |
| CONTACT | | | | | | | |
| ANGLE | | | | | | | |
| H₂O θ_{Adv} | 139 | 151 | 152 | 135 | 153 | 143 | 146 |
| H₂O θ_{Rec} | 25 | — | — | — | — | — | — |
| HD θ_{Adv} | 115 | 143 | 110 | 40 | 134 | 47 | 135 |
| HD θ_{Rec} | — | — | — | — | — | — | — |
| DSC | | | | | | | |
| Tₑᵢₘ (° C.) | | −16.7 | −17.1 | −22.7 | −19.5 | −21.5 | −24.1 |
| Tₚₘ (° C.) | | 1.9 | −2.7 | −7.6 | 0.1 | −3.2 | −4.2 |
| T_{efm} (° C.) | | 7.5 | 3.4 | −1.1 | 5.7 | 5.4 | 6.3 |
| ΔH_{f} (J/g) | | 28.6 | 26.3 | 18.7 | 27.9 | 18.5 | 28.7 |
| T_{eic} (° C.) | | −7.6 | −10.1 | −11.2 | −9.5 | −10 | −9.5 |
| T_{pc} (° C.) | | −9.7 | −12.5 | −16 | −11.6 | −12.9 | −10.2 |
| ΔH_{c} (J/g) | | 28.3 | 22.2 | 17.9 | 27.5 | 22.3 | 25.0 |

Table 9, below, reports the relative weight of monomer components present excluding the solvent and initiator (i.e., the composition of the resulting copolymer after coating and drying) for copolymers EX-13 and CE-D to CE-K as well as the contact angles measured for water and hexadecane test fluids on coatings of the copolymers.

TABLE 9

| | RELATIVE MONOMER AMOUNT, parts by weight | | | | | | | | |
|---|---|---|---|---|---|---|---|---|---|
| MONO- | CE- | CE- | CE- | CE- | CE- | EX- | CE- | CE- | CE- |
| MER | D | E | F | G | H | 13 | I | J | K |
| AA | 3.0 | 3.0 | 3.0 | 3.0 | 3.0 | 3.0 | 3.0 | 3.0 | |
| 2EHA | 97.0 | | | | | | | | |
| HMA | | 97.0 | | | | | | | |
| TDA | | | 97.0 | | | | | | |
| HDA | | | | 97.0 | | | | | |
| tBA | | | | | 97.0 | | | | |
| M3 | | | | | | 97.0 | | | |
| M4 | | | | | | | 97.0 | | |
| M2 | | | | | | | | 97.0 | |
| M1 | | | | | | | | | 100 |
| H₂O θ_{Adv} | 125 | 110 | 150 | 110 | 84 | 145 | 99 | 95 | 87 |
| H₂O θ_{Rec} | 30 | 25 | — | 98 | 68 | — | 63 | 26 | 55 |
| HD θ_{Adv} | 37 | 10 | 73 | 43 | 27 | 143 | 32 | — | 42 |
| HD θ_{Rec} | — | — | — | 41 | — | — | — | — | — |
| Tₑᵢₘ (° C.) | ntd | tgd | 17.4 | | tgd | −0.9 | 128.8 | −24.1 | −13.0 |
| Tₚₘ (° C.) | ntd | tgd | 20.2 | | tgd | 6.8 | 132.5 | −7.9 | 5.0 |
| T_{efm} (° C.) | ntd | tgd | 22.0 | | tgd | 17.4 | 135.1 | 0.1 | 10.0 |
| ΔH_{f} (J/g) | ntd | tgd | 41.8 | | tgd | 25.7 | 10.2 | 11.9 | 30.2 |
| T_{eic} (° C.) | ntd | tgd | 13.9 | | tgd | 2.5 | 129.6 | −17.5 | −6.4 |
| T_{pc} (° C.) | ntd | tgd | 13.2 | | tgd | 0.7 | 128.5 | −23.4 | −8.9 |
| ΔH_{c} (J/g) | ntd | tgd | 51.3 | | tgd | 24.0 | 10.9 | 13.2 | 34.7 |

Table 10, below, reports the ratio of monomer components present excluding the solvent (i.e., the composition of the resulting copolymer after coating and drying) for copolymers EX-14 to EX-17 and CE-L to CE-R and the contact angles measured for water and hexadecane test fluids on coatings of the copolymers, and DSC measured thermal parameters of the dried copolymers.

TABLE 10

| | RELATIVE MONOMER AMOUNT, parts by weight | | | | | | | | | | |
|---|---|---|---|---|---|---|---|---|---|---|---|
| MONOMER | EX-14 | EX-15 | EX-16 | CE-L | CE-M | CE-N | CE-O | CE-P | CE-Q | CE-R | EX-17 |
| AA | 3.0 | 3.0 | 3.0 | 3.0 | 3.0 | 3.0 | 3.0 | 3.0 | 3.0 | 3.0 | 3.0 |
| M5 | 97.0 | | | | | | | | | | |
| M6 | | 97.0 | | | | | | | | | |
| M7 | | | 97.0 | | | | | | | | |
| M8 | | | | 97.0 | | | | | | | |
| M9 | | | | | 97.0 | | | | | | |
| M10 | | | | | | 97.0 | | | | | |
| M11 | | | | | | | 97.0 | | | | |
| M12 | | | | | | | | 97.0 | | | |
| M13 | | | | | | | | | 97.0 | | |
| M14 | | | | | | | | | | 97.0 | |
| M15 | | | | | | | | | | | 97.0 |
| CONTACT | | | | | | | | | | | |
| ANGLE | | | | | | | | | | | |
| H₂O θ_{Adv} | 145 | 142 | 97 | 129 | 130 | 123 | 121 | 103 | 105 | 104 | 145 |
| H₂O θ_{Rec} | — | 23 | 52 | — | — | — | — | 89 | 76 | 87 | — |
| HD θ_{Adv} | 96 | 115 | 138 | 37 | — | — | — | 43 | — | — | 150 |
| HD θ_{Rec} | — | — | — | — | — | — | — | 39 | — | — | — |
| DSC | | | | | | | | | | | |
| Tₑᵢₘ (° C.) | 16.4 | 0.7 | 13.5 | −27.8 | −19.9 | −30.8 | ntd | 61.9 | 66.8 | 68.6 | * |
| Tₚₘ (° C.) | 24.3 | 19.6 | 28.3 | −17.1 | −12.6 | −22.6 | ntd | 65.3 | 87 | 80.4 | * |
| T_{efm} (° C.) | 27.6 | 28.7 | 33.2 | −10.5 | −6.4 | −15.4 | ntd | 67 | 94.3 | 84.6 | * |
| ΔH_{f} (J/g) | 27.6 | 24.1 | 13.8 | 7 | 11.3 | 12.4 | ntd | 36.1 | 11.3 | 20 | * |
| T_{eic} (° C.) | 10.8 | 4.4 | 25 | −12.3 | −11.1 | −22.1 | ntd | 53.5 | 71.8 | 68.4 | * |
| T_{pc} (° C.) | 9 | 1.6 | 21.5 | −22.8 | −17.8 | −27.9 | ntd | 52.6 | 66.2 | 64 | * |
| ΔH_{c} (J/g) | 27.6 | 27.4 | 12.1 | 4.9 | 12.3 | 7.6 | ntd | 39.4 | 10.4 | 18.4 | * |

Table 11, below, reports the ratio of monomer components present excluding the solvent (i.e., the composition of the resulting copolymer after coating and dying) for copolymers EX-18 to EX-24, CE-S, and CE-T and the contact angles measured for water and hexadecane test fluids on coatings of the copolymers, and DSC measured thermal parameters of the dried copolymers.

TABLE 11

| | RELATIVE MONOMER AMOUNT, parts by weight | | | | | | | | |
|---|---|---|---|---|---|---|---|---|---|
| MONOMER | EX-18 | EX-19 | EX-20 | CE-S | EX-21 | CE-T | EX-22 | EX-23 | EX-24 |
| AA | 5.9 | 5.9 | 5.9 | 5.9 | 5.9 | 5.9 | 5.9 | 5.9 | 3.0 |
| M1 | 27.5 | 22.5 | 17.5 | 20.0 | 29.9 | 47.0 | | 47.0 | |
| HPA | 39.0 | 49.0 | 59.0 | 14.8 | 14.8 | | | | |
| ODA | 27.5 | 22.5 | 17.5 | 59.2 | 49.2 | | 47.0 | | |
| DDA | | | | | | 47.0 | | | |
| M8 | | | | | | | 47.0 | | |
| ODMA | | | | | | | | 47.0 | |
| M16 | | | | | | | | | 97.0 |
| CONTACT ANGLE | | | | | | | | | |
| H₂O θ_{Adv} | 166 | 149 | 139 | 111 | 110 | 133 | 131 | 130 | 144 |
| H₂O θ_{Rec} | — | — | 24 | 89 | 86 | 20 | 65 | 70 | — |
| HD θ_{Adv} | 122 | 143 | 130 | 43 | 106 | 45 | 141 | 135 | 127 |
| HD θ_{Rec} | — | — | 22 | 37 | 33 | — | — | — | — |
| DSC | | | | | | | | | |
| Tₑᵢₘ (° C.) | 4.1 | −10.5 | −16.9 | 34.8 | 29.6 | −17.6 | 22 | 15 | −24.3 |
| Tₚₘ (° C.) | 22.5 | 19.5 | 12.7 | 38.3 | 34.1 | −11.3 | 29.3 | 25.9 | −11.3 |
| T_{efm} (° C.) | 28.3 | 26.5 | 26.4 | 40.4 | 36.9 | −8.2 | 31.4 | 28.3 | 4.3 |
| ΔH_{f} (J/g) | 25.2 | 20.4 | 19.2 | 47.3 | 29.8 | 22.9 | 32.3 | 28.3 | 10.2 |
| T_{eic} (° C.) | 16.1 | 14.1 | 11.7 | 30 | 25.4 | −17.2 | 21.2 | 16 | −8.8 |
| T_{pc} (° C.) | 11.4 | 6.8 | 0.2 | 29 | 24.6 | −18.9 | 20.1 | 17.1 | −20.6 |
| ΔH_{c} (J/g) | 23.9 | 17.9 | 11.8 | 41.6 | 35.7 | 29.3 | 30.3 | 25.7 | 5.8 |

The preceding description, given in order to enable one of ordinary skill in the art to practice the claimed disclosure, is not to be construed as limiting the scope of the disclosure, which is defined by the claims and all equivalents thereto.

1. A copolymer preparable by free-radical copolymerization of components comprising:
a) 1 to 85 weight percent of at least one of:
i) at least one C₃-C₁₀ carboxyl-functional monoacrylate or salt thereof; or
ii) at least one C₅-C₁₆ hydroxyalkyl mono(meth)acrylate;
b) 15 to 99 weight percent of at least one acrylate represented by the formula 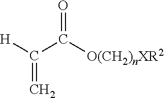
wherein:
each n is independently an integer from 0 to 18, inclusive;
each X is independently O, NR¹ wherein R¹ is H or methyl, S, C(═O)O, OC(═O), C₂-C₁₀ hydrocarbylene, or a covalent bond, with the proviso that if n=0, then X is a covalent bond; and
each R² is independently:
1) a C₅-C₅₀ hydrocarbyl group having 1 to 3 rings comprising at least one tert-butyl or C₁-C₁₂ linear alkyl group; or
2) 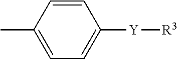
wherein each Y is independently O, NR¹, S, C(═O)O, OC(═O), OC(═O)O, or a covalent bond, and each R³ is independently C₁-C₁₆ linear alkyl group; and
c) optionally up to 55 weight percent of at least one C₁₄-C₃₀ linear alkyl mono(meth)acrylate, wherein all of the preceding weight percents are based on the total weight of the copolymer, and wherein according to ASTM test method D3418-21 (2021) the copolymer has a melting extrapolated end temperature T_{efm} between −0.5 and 40° C., inclusive.

2. The copolymer of claim 1, wherein the components comprise 1 to 35 weight percent of component a).

3. The copolymer of claim 1, wherein component b) and component c) are present in a respective weight ratio of greater than 0.5.

4. The copolymer of claim 1, wherein component b) melts at a temperature of at most 49° C.

5. The copolymer of claim 1, wherein the copolymer contains at most 13 weight percent of polydimethylsiloxane segments.

6. The copolymer of claim 1, wherein component a) comprises less than 40 weight percent of components a), b), and c) combined, and wherein the weight percent of component a) is at most 10 percent larger than the weight percent of component b).

7. The copolymer of claim 1, wherein component b) comprises 15 to 99 weight percent of the components a), b), and c) combined.

8. The copolymer of claim 1, wherein R² comprises a phenyl group covalently bound to a single C₁-C₈ linear alkyl group.

9. The copolymer of claim 1, wherein each n is independently in the range of 9 to 17, inclusive.

10. The copolymer of claim 1, wherein Y represents O or a covalent bond.

11. A method of using the copolymer of claim 1, the method comprising applying the copolymer to a substrate.

12. The method of claim 11, wherein the substrate comprises at least one of fabric or leather.

13. The method of claim 14, wherein the substrate comprises at least one of apparel, upholstery, a tent, and umbrella, a rug or carpet.

14. A method of making a copolymer, the method comprising:
combining a free-radical initiator with free-radically copolymerizable monomer components comprising:
a) 1 to 85 weight percent of at least one of:
i) at least one C₃-C₁₀ carboxyl-functional monoacrylate or salt thereof; or
ii) at least one C₅-C₁₆ hydroxyalkyl mono(meth)acrylate;
b) 15 to 99 weight percent of at least one acrylate represented by the formula 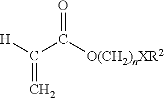
wherein:
each n is independently an integer from 0 to 18, inclusive;
each X is independently O, NR¹ wherein R¹ is H or methyl, S, C(═O)O, OC(═O), C₂-C₁₀ hydrocarbylene, or a covalent bond, with the proviso that if n=0, then X is a covalent bond; and
each R² is independently:
1) a C₅-C₅₀ hydrocarbyl group having 1 to 3 rings comprising at least one tert-butyl or C₁-C₁₂ linear alkyl group; or
2) 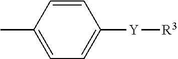
wherein each Y is independently O, NR¹, S, C(═O)O, OC(═O), OC(═O)O, or a covalent bond, and each R³ is independently a C₁-C₁₆ linear alkyl group; and
c) optionally up to 55 weight percent of at least one C₁₄-C₃₀ linear alkyl mono(meth)acrylate, wherein all of the preceding weight percents are based on the total weight of the copolymer; and
decomposing the free-radical initiator and causing copolymerization of the monomer components.
